(19) United States
(12) Patent Application Publication
(10) Pub. No.: US 2002/0145084 A1
(43) Pub. Date: Oct. 10, 2002

(54) Cable tray with modified spine

(76) Inventor: Jordan Handler, Rye Brook, NY (US)

Correspondence Address: OSTROLENK FABER GERB & SOFFEN, 1180 AVENUE OF THE AMERICAS, NEW YORK, NY, 100368403

(21) Appl. No.: 10/103,298

(22) Filed: Mar. 19, 2002

Related U.S. Application Data
(60) Provisional application No. 60/277,139, filed on Mar. 19, 2001.

(51) Int. Cl. F16L 3/00; E21F 17/02

(52) U.S. Cl. 248/58; 248/68.1

(57) ABSTRACT

In cable tray, particularly cable tray with a central spine and laterally projecting arms, a bracket secured to the top and the bottom ends of the spine for holding a device in place through which cable runs. The bracket includes an inclined front face side that hooks to the top of the spine and a second horizontal side that attaches at the bottom of the spine and an opening through the inclined face of the bracket provides access to the device supported in the device.

This application is based upon and claims benefit of United States Provisional Application No. 60/277,139, filed on Mar. 19, 2001, to which a claim of priority is hereby made.

### BACKGROUND OF THE INVENTION

The invention concerns a cable tray and is particularly useful with a specific embodiment a cable tray comprised of an elongate central spine with cable supporting arms radiating laterally from the spine. An example of such a cable tray is found in U.S. Pat. No. 5,323,988, incorporated by reference for its relevant teachings. Such a tray does not have a separate device support bracket along its spine.

### SUMMARY OF THE INVENTION

The present invention has an objective to enable a support bracket to be installed on the spine of the cable tray. The bracket may be a support for a telecommunications data surface mount housing or for another housing of a device, which housing has cables communicating with it that are to be supported on the cable tray.

In comparison with the conventional spine of a cable tray, the spine of this tray may be taller, e.g. up to four inches in height, to accommodate a standard telecommunications device. A shorter spine would not as well match the standard device units. Other types of devices may be attached to the spine as well.

It previously might not have been possible to attach the devices directly to the cable tray. The present cable tray with a modified spine allows for a bracket to support a device to be attached at a selected location along the spine or several brackets to be attached at spaced intervals along the spine.

These attached devices may be “hard wired”. The device is supported on the cable tray at a location as close as possible to where its use in required. For example, the cable tray with supported devices may be used to produce a plug in system for testing equipment in a laboratory. Current laboratory installations require equipment to be hard wired. With prior art systems, hard wiring may require a labor intensive effort to initially outfit the laboratory with device system. Outfitting a laboratory initially is made much easier.

The bracket for supporting a device to the spine of the cable tray may have only two sides, including a bottom side that extends beneath the spine of the tray and that includes tangs that hold the bracket to the spine and an inclined side extends from the bottom side and that is attached or hooked to the top of the spine. The bracket may have the particular shape illustrated in the drawings here, with punched out and folded over engaging tangs or may be otherwise shaped to provide the attachment to the top and bottom of the spine.

Other bracket arrangements and other shape brackets may be provided, to be consistent with the shape of the spine of the tray and with the size and shape of the device being mounted.

The spine is shown as generally a U-shaped bent rail with a cross bar, giving the unit a generally A-shape. Other shape spines may be used, including a solid spine, an enclosed rectangle, etc. and the bracket would be suitably adapted to this.

One spine may be used. Two parallel elongate spines may be used. Other arrangements of spines may be used.

Cable wires exit the device supported on the bracket. The wires may be carried along the arms or rungs of the cable tray in the usual manner to where they are needed, e.g. for laboratory equipment, etc.

### BRIEF DESCRIPTION OF THE DRAWINGS

FIG. 1 is a perspective view of a section of a cable tray showing a modified spine and bracket according to the invention;

FIG. 2 is a view at the end of a bracket showing a bracket and spine portion of the cable tray section in FIG. 1;

FIG. 3 is an enlarged view of the section of cable tray in FIG. 2;

FIG. 4 is a perspective view of an alternate embodiment; and

FIG. 5 is an end view thereof.

### DESCRIPTION OF PREFERRED EMBODIMENTS

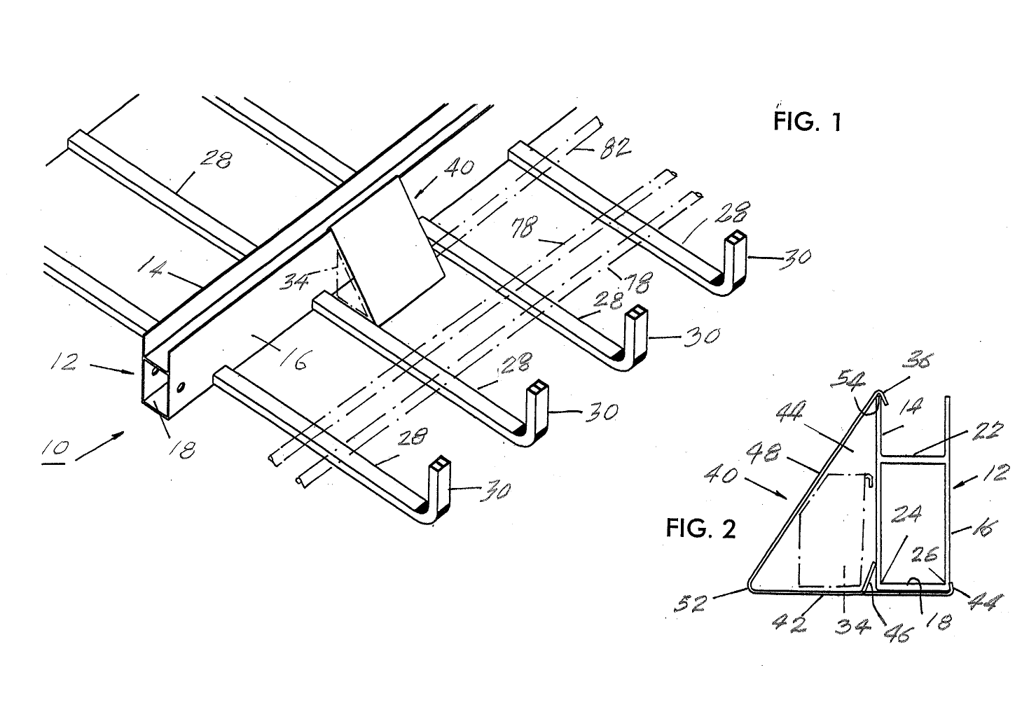

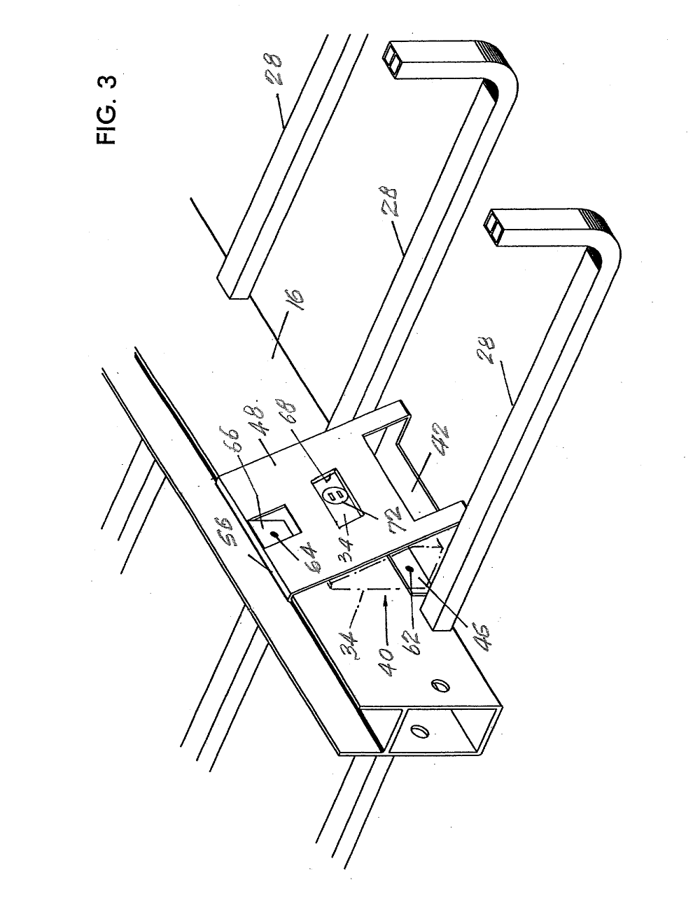

A cable tray section with which the modified spine and bracket according to the invention are shown as illustrated in FIGS. 1-3, as one embodiment.

The cable tray itself may be of a type shown in U.S. Pat. No. 5,323,988, incorporated by reference. The cable tray comprises a central spine 12 illustrated here as comprised of a generally U-shaped or A-shaped part with opposite arms 14, 16, a base 18 forming the base of the U and an optional rigidifying integrated cross-bar 22 between the arms 14, 16 giving an A-shape. For convenience of attachment of bracket 30 for an electrical device, the sides 14, 16 are straight upstanding and intersect the base 18 at sharp right angle corners, 24, 26.

Referring to FIG. 1, as is known from U.S. Pat. No. 5,323,988, at spaced intervals along the tray segment 10, there are elongate arms 28 which project from the opposite sides of the spine. Actually, the arms 28 may be formed of a single arm that passes through the spine 12. The opposite outer ends of the arms 28 are bent upwardly at short arms 30, whereby open and accessible cable tray is defined at arms 28 between spine wall 16 and upstanding arms 30 and also between spine wall 14 and the corresponding upstanding arms at the other end of the arms 28. There is a uniform gap spacing between adjacent arms 28 which are close enough together to support cable along the length without excessive sag of the cable between the arms 28.

When it is desired to retain some electrical device 34 at the cable tray where it may be hard wired and securely held in place so that laboratory equipment might be plugged directly into the particular device 34, the spine of the cable tray holds a bracket 40 which holds the device box or housing securely to the cable tray spine so that cables may be carried to the device box to hard wire it, and the device box can be positioned in the laboratory or at another location where it is needed, or at least where it is most easily accessible along the cable tray. The cable tray may extend along the length and/or the width of the room or laboratory.

The illustrated bracket 40 has a relatively simple V-shape, including an extended bottom side 42 that defines the open space 44 into which the device 34 is disposed and that extends toward and beneath the underside 18 of the spine 12. The end of the bottom leg 42 terminates in a engaging hook shape bend 44, which hooks to the outside of the opposite wall 16 from the side at which the bracket 40 is positioned, and also includes a bent up tang 46 that resiliently presses against the proximal wall 14, so that the bottom of the bracket 12 is held between the hook 44 and the tang 46 and is secured there.

The bracket 40 further includes the inclined outer wall 48 which inclines from its bottom at a rounded junction 52 with the bottom wall 42 to the top edges 4 of the spine wall 14. The bracket wall 48 has a top hook 56 which is bent over and hooks the top edge 54 of the spine securing the bracket 40 to the spine, both at the top and the bottom so that the bracket is anchored tightly. The bracket is shaped preferably cooperatively with the device 34 held within it so that the device is fixed.

Further securement of the bracket to the spine is obtained by appropriate fasteners such as a bolt which passes through openings 62 in the tang 46 and through opening 64 in the bent down tab 66 punched out of the wall 48 and folded in against the spine wall 16. For added securement of the bracket 40, its lateral width is slightly less than the space between adjacent arms 28 of the cable tray so as to fit between those arms and be held there against movement.

The surface of the arm 48 of the bracket has an opening 68 through it providing access to a connector 72, e.g. a plug socket, which is at the outward face of the device 34, for example. A pattern of openings in the bracket 48 corresponds to various connections to the devices 34 inside the bracket.

Cable tray has as its purpose the support of cable which supplies various devices. Representative cable on the tray is shown at 78. The device 34 in the bracket 40 is also hardwired and cable 82 from that device also rests on the arms 28. Hence, the cable tray carries the cable directly to the hard-wired fixed position device 34.

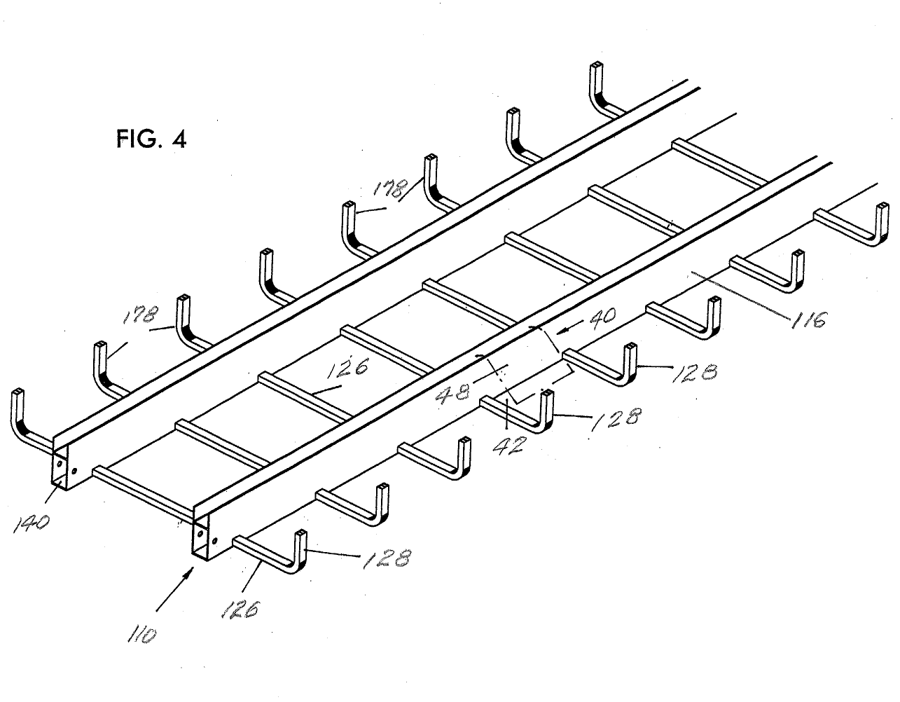

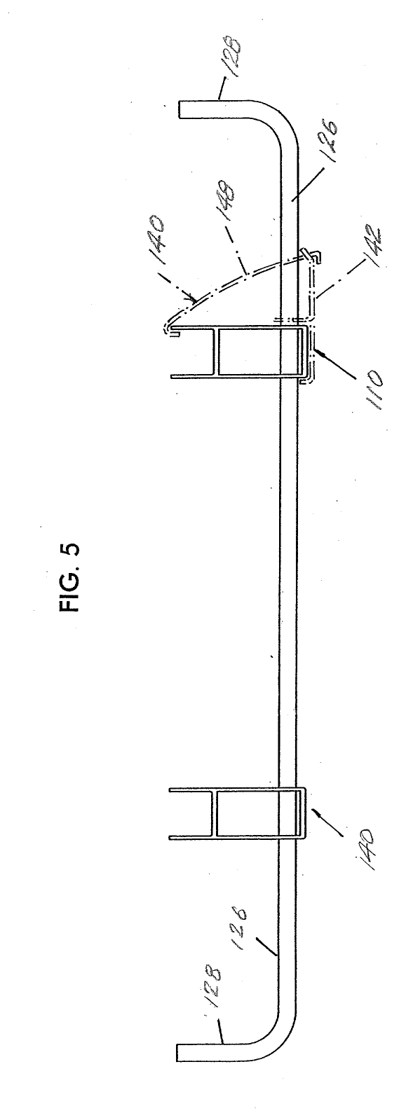

A second embodiment of cable tray adopts the same construction and operational principles as the first embodiment, but has two spines 110, 140 rather than one. The arms 126 end in the upstanding arms 130 that define the tray between the bracket wall 116 and the upstanding arms 130. There is a separate spine 110 and another spine 140 spaced apart across the bars 126, so that cable can be carried both between the spines and the arms 130 at the ends and also along the part of the tray between the spines 110 and 140. In other respects, the cable tray seen in FIGS. 4 and 5 corresponds to that in the first three Figures and further details as to the cable tray, the cables, the bracket 140 and the device held thereby and the cables transmitted thereby are not provided, since they can be understood from the first embodiment.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A cable tray comprising
a longitudinally extending spine having lateral sides;
at least one laterally extending arm arrangement at at least one side of the spine for supporting cable running along the arm arrangement; the spine being elevated to a height above the arm arrangement;
a bracket of a height sufficient to support a housing at the bracket, the bracket including a first side that is attached to a top of the spine and a second side that is secured to the bottom of the spine and the bracket being shaped and oriented for holding the device in the bracket on the spine; the bracket extending part of the length longitudinally along the spine.

2. The cable tray of claim 1, wherein the arm arrangement projects laterally from both lateral sides of the spine.

3. The cable tray of claim 1, wherein the bracket first side is attached to the top of the spine and is inclined outward from the spine and the bracket second side is attached to the first side and extends beneath the spine and is attached to the bottom of the spine.

4. The cable tray of claim 3, wherein the arm arrangement comprises a series of parallel arms extending outward from the spine at locations spaced longitudinally along the spine, and the bracket being of a width to extend longitudinally along the spine to fit between adjacent arms.

5. The cable tray of claim 3, wherein the first side of the bracket has an opening therethrough positioned to provide access to a device supported under the first arm for enabling connection through the bracket arm to the device.

6. The cable tray of claim 1, wherein the first and second bracket sides include fixtures thereon for being secured to the spine and the spine having fixtures thereon and being shaped to receive the fixtures from the bracket.

7. The cable tray of claim 3, wherein the first and second bracket sides include fixtures thereon for being secured to the spine and the spine having fixtures thereon and being shaped to receive the fixtures from the bracket.

8. The cable tray of claim 7, further comprising the spine having two sides laterally separated, the first side of the spine having a top thereof and the first side of the bracket being secured by a fixture at a top of the first arm of the spine;
the second side of the bracket extending below the spine including a first fixture that engages one arm of the spine and a second fixture that engages the other arm of the spine for holding to the spine.
